(19) United States
(12) Patent Application Publication
(10) Pub. No.: US 2010/0075227 A1
(43) Pub. Date: Mar. 25, 2010

(54) NONAQUEOUS ELECTROLYTE BATTERY AND NEGATIVE ELECTRODE ACTIVE MATERIAL

(76) Inventors: Tomokazu MORITA, Funabashi-shi (JP); Norio TAKAMI, Yokohama-shi (JP); Hiroki INAGAKI, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/559,866

(22) Filed: Sep. 15, 2009

(30) Foreign Application Priority Data
Sep. 22, 2008 (JP) 2008-243045

(51) Int. Cl. H01M 4/96

(52) U.S. Cl. 429/231.8; 252/182.1

(57) ABSTRACT

A negative electrode active material includes complex particles and a carbonaceous material phase which binds the complex particles. The complex particles comprises a metal oxide having an average size of 50 nm to 1 μm and SiOₓ (0≦x≦0.8) supported on a surface of the metal oxide.

### CROSS-REFERENCE TO RELATED APPLICATIONS

This application is based upon and claims the benefit of priority from prior Japanese Patent Application No. 2008-243045, filed Sep. 22, 2008, the entire contents of which are incorporated herein by reference.

### BACKGROUND OF THE INVENTION

1. Field of the Invention

The present invention relates to a nonaqueous electrolyte battery and a negative electrode active material.

2. Description of the Related Art

Various portable electronic devices have been recently distributed with rapid developments of miniaturization technologies of electronics devices. It is desired to develop small-sized batteries as power sources of these portable electronic devices and therefore, nonaqueous electrolyte batteries having a high energy density attract remarkable attention.

A nonaqueous electrolyte secondary battery using metal lithium as the negative electrode active material has a very high energy density. However, this battery has a short cycle life because dendritic crystals called “dendrite” are precipitated on the negative electrode at the time of charging and also, poses safety problems including the problem that dendrite grows to reach the positive electrode, causing internal short-circuiting. In light of this, a carbon material which absorbs and desorbs lithium and particularly, graphitized materials have come to be used as the negative electrode active material in place of a lithium metal. However, the capacity of the graphitized material is smaller than that of a lithium metal or lithium alloy, giving rise to problems concerning deterioration in large-current performance. In view of this, attempts have been made to use a material having a high lithium absorbing capacity and a high density such as silicon and tin which are alloyed with lithium, or amorphous chalcogen compounds. Among these materials, silicon can absorb lithium atoms in a ratio up to 4.4 per one silicon atom. The capacity of the negative electrode per weight is about 10 times that of the graphitized material. However, silicon greatly varies in volume along with the insertion and desorption of lithium in charge-discharge cycle, posing problems concerning cycle life because of pulverization of the active material particles.

The inventors of the present invention have earnestly made empirical studies and, as a result, found that a battery which has a high-capacity and is improved in cycle performance can be attained by using an active material which is obtained by compounding and baking fine silicon monoxide and a carbonaceous material and in which microcrystalline Si is dispersed in the carbonaceous material in the condition that Si is firmly combined with SiO₂ and included in or supported by SiO₂. The inventors of the invention have disclosed this fact in JP-A 2004-119176 (KOKAI).

However, the active material described in JP-A 2004-119176 (KOKAI) is more deteriorated in large-current performance at charging/discharging time than graphite negative electrode active material because silicon primarily carrying out the absorption of lithium is included in silicon oxide having low electroconductivity and lithium ion-conductivity. Specifically, the battery is reduced in energy density by a reduction in voltage caused by overvoltage in discharge under a large current, and also charge current cannot be increased. This poses the problem that time is required for charging and also the problem that SiO left unreacted causes a reduction in first charge-discharge efficiency.

JP-A 2005-259697 (KOKAI) discloses a lithium secondary battery negative electrode active material containing a silicon-type complex containing at least one element selected from the group consisting of B, P, Li, Ge, Al, V or mixtures of these elements and silicon oxide (SiOₓ, x being 1.5 or less) and a carbonaceous material. The negative electrode active material described in JP-A 2005-259697 (KOKAI) has the problem that because the silicon-type complex is doped with elements such as B, silicon monoxide constituting the silicon-type complex is pulverized, so that the large-current performance are deteriorated and a development of a high-capacity battery is hindered.

### BRIEF SUMMARY OF THE INVENTION

According to a first aspect of the present invention, there is provided a negative electrode active material comprising:

complex particles comprising a metal oxide having an average size of 50 nm to 1 μm and SiOₓ (0≦x≦0.8) supported on a surface of the metal oxide; and

a carbonaceous material phase which binds the complex particles.

According to a second aspect of the present invention, there is provided a nonaqueous electrolyte battery comprising:

a negative electrode comprising a negative electrode active material;

a positive electrode; and

a nonaqueous electrolyte,

wherein the negative electrode active material comprises complex particles comprising a metal oxide having an average size of 50 nm to 1 μm and SiOₓ (0≦x≦0.8) supported on a surface of the metal oxide; and

a carbonaceous material phase which binds the complex particles.

According to a third aspect of the present invention, there is provided a negative electrode active material comprising:

a complex particle comprising a metal oxide having an average size of 50 nm to 1 μm and SiOₓ (0≦x≦0.8) supported on a surface of the metal oxide; and

a carbonaceous material phase which covers a surface of the complex particle.

According to a forth aspect of the present invention, there is provided a nonaqueous electrolyte battery comprising:

a negative electrode comprising a negative electrode active material;

a positive electrode; and

a nonaqueous electrolyte,

wherein the negative electrode active material comprises a complex particle comprising a metal oxide having an average size of 50 nm to 1 μm and SiOₓ (0≦x≦0.8) supported on a surface of the metal oxide; and

a carbonaceous material phase which covers a surface of the complex particle.

### BRIEF DESCRIPTION OF THE SEVERAL VIEWS OF THE DRAWING

FIG. 1 is a schematic view of a negative electrode active material according to an embodiment;

FIG. 2 is a schematic view of a negative electrode active material according to another embodiment; and

FIG. 3 is a partially broken sectional view showing a cylinder-type nonaqueous electrolyte secondary battery according to an embodiment.

### DETAILED DESCRIPTION OF THE INVENTION

The present invention has been made in view of the above problem.

The details of the negative electrode active material for a nonaqueous electrolyte battery according to this embodiment will be explained.

The negative electrode active material according to one aspect contains SiOₓ (0≦x≦0.8), a metal oxide phase such as alumina and a carbonaceous material phase, wherein microparticles of SiOₓ (0≦x≦0.8) are bonded to the surface of the metal oxide phase to form complex particles and the surface of the complex particles is coated with the carbonaceous material phase. Also, a material in which plural complex particles are coagulated may be coated with the carbonaceous material phase.

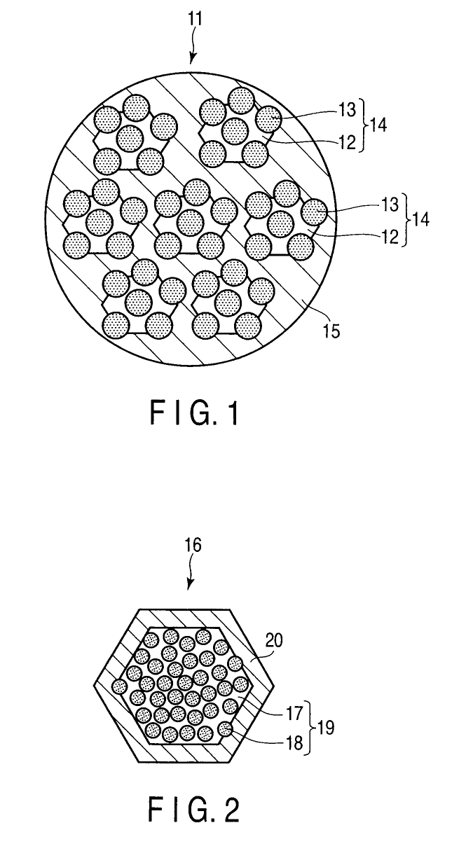

A schematic view of the negative electrode active material is shown in FIGS. 1 and 2.

A negative electrode active material 11 shown in FIG. 1 comprises plural complex particles 14 in which SiOₓ (0≦x≦0.8) particles 13 are supported on the surface of a metal oxide phase 12 having an average size in the range of 50 nm to 1 μm, and a carbonaceous material phase 15 which is interposed between the plural complex particles 14 and binds these complex particles 14 to each other. Also, the carbonaceous material phase 15 constitutes the outermost layer of the negative electrode active material 11.

A negative electrode active material 16 shown in FIG. 2 comprises a complex particle 19 in which SiOₓ (0≦x≦0.8) particles 18 are supported on the surface of a metal oxide phase 17 having an average size in the range of 50 nm to 1 μm, and a carbonaceous material phase 20 which serves as the outermost layer which covers the surface of the complex particle 19.

Silicon contained in the complex particles absorbs and desorbs a lot of lithium to promote an increase in the capacity of the negative electrode active material. The expansion and shrinkage of silicon caused by the insertion and desorption of a lot of lithium in silicon are alleviated by dispersing silicon in other two phases consisting of metal oxide phase and carbonaceous material phase to prevent the active material particles from being pulverized, and also, the carbonaceous material phase secures conductivity important for the negative electrode active material and the metal oxide phase is firmly bound with silicon and is a buffer holding the pulverized silicon phase. As a result, a large effect to maintain the particle structure of the complex particles is obtained. High charge-discharge capacity, and a long cycle life can be obtained by these effects.

The negative electrode active material disclosed in JP-A 2004-119176 (KOKAI) causes a side reaction to produce lithium silicate on silicon oxide in the first charging. This involves a loss of lithium and therefore, the capacity efficiency in the first charge-discharge is dropped. In the case of the negative electrode active material according to this embodiment, a metal oxide stable to lithium is used as a fixed phase of a nano-size silicon phase to thereby limit a loss of lithium, making it possible to improve the first charge-discharge efficiency. Also, the SiOₓ (0≦x≦0.8) particles are retained on the surface of the metal oxide phase, leading to an increase in contact area between the highly conductive carbonaceous material phase and the SiOₓ particles, thereby enabling an improvement in the large-current performance of the nonaqueous electrolyte battery.

Therefore, the negative electrode active material according to this embodiment can attain high charge-discharge capacity, the first charge-discharge capacity efficiency, long cycle life and good large-current performance at the same time.

The reason why the range of x in the formula: SiOₓ (0≦x≦0.8) is defined will be explained. When x is 0, a high-capacity and long-life negative electrode active material is obtained even in the case where x is 0, if the silicon phase having a sufficiently small size is combined with the metal oxide by using vapor deposition. When x>0, a good structure in which the silicon oxide phase is combined with the nano-size silicon phase is obtained, whereas when x exceeds 0.8, unreacted SiO remains even after heat treatment, giving rise to the problem that the initial charge-discharge capacity efficiency is dropped. The following range is more preferable: 0≦x≦0.6.

The silicon phase in SiOₓ (0≦x≦0.8) greatly expands or shrinks when absorbing or disserving lithium and is therefore preferably micronized and dispersed as much as possible to alleviate this stress caused by the above expansion and shrinkage. Specifically, SiOₓ is preferably dispersed as particles having a size ranging from a cluster size of several nanometers to 300 nm. To mention a more preferable range, the silicon crystal size found by X-ray diffraction method is in the range of 1 to 300 nm. The silicon crystal size is more preferably in the range of 1 to 80 nm.

The reason why the average size of the metal oxide phase is limited to the range of 50 nm to 1 μm will be explained. When the average size of the metal oxide phase is less than 50 nm, the ability of supporting SiOₓ is insufficient because of a relatively small difference in size from that of SiOₓ. Also, when the average size exceeds 1 μm, the surface area is reduced, leading to an insufficient amount of SiOₓ being supported. The average size is more preferably in the range of 100 nm to 1 μm.

As the metal oxide phase, an amorphous, crystalline or other structure may be adopted. The metal oxide phase is preferably dispersed without uneven distribution in the active material in the condition that a silicon oxide phase {SiOₓ (0≦x≦0.8) phase} is bond to its surface. Example of the metal oxide include alumina (Al₂O₃), magnesia (MgO), zirconia (ZrO₂), ceria (CeO₂), titania (TiO₂) and glass materials (silica-alumina glass). The metal oxide is preferably an oxide having the same or higher stability than silica (SiO₂) in order to support the silicon oxide phase on its surface.

Examples of the carbonaceous material to be combined with the silicon phase inside the particle may include graphite, hard carbon, soft carbon, amorphous carbon and acetylene black. One or more types of carbonaceous materials may be used to constitute the carbonaceous material phase. Single graphite or a mixture of graphite and hard carbon is preferable. Graphite is preferred in that it raises the conductivity of the active material and hard carbon covers the entire active material to produce a large effect of suppressing expansion and shrinkage. The carbonaceous material phase preferably has a configuration including the silicon oxide phase and the metal oxide phase as illustrated in FIGS. 1 and 2.

The carbonaceous material phase preferably contains amorphous carbon of which the half-value width of the peak derived from the (002) plane of a graphite structure in X-ray diffraction is 1° or more in terms of 2 theta angle (2θ). This can more improve the effect of suppressing expansion and shrinkage. The upper limit of the half-value width is preferably designed to be 10° in terms of 2 theta angle (2θ).

The carbonaceous material phase is preferably an amorphous body obtained by baking an Si-containing polymer. This makes it possible to improve the binding strength between the carbonaceous material phase and the SiOₓ (0≦x≦0.8) phase and therefore, the pulverization of the active material particles is more limited. Examples of the Si-containing polymer may include tetraethoxysilane (chemical formula: Si(OC₂H₅)₄).

The negative electrode active material preferably has an average particle diameter in the range of 5 to 100 μm and a specific surface area in the range of 0.5 to 10 m²/g. The active material can exhibit its characteristics stably when the average particle diameter and specific surface area fall in the above ranges, though these values affect the rate of the insertion and desorption of lithium and therefore has a large influence on the performance of the negative electrode.

Also, the half-value width of the diffraction peak derived from the Si (220) plane in powder X-ray diffraction of the active material is preferably in the range of 1.5° to 4° in terms of 2 theta angle (2θ). The diffraction peak half-value width of the Si (220) plane is smaller as the crystal particle of the silicon phase is more grown. When the crystal particles of the silicon phase are grown to be large, the active material particles are easily broken with expansion and shrinkage caused by the insertion and desorption of lithium. When the half-value width is designed to be in the range of 1.5° to 4° in terms of 2 theta angle (2θ), the situation where such a problem arises can be avoided.

The active material preferably satisfies formula (I) given below:

0.5≦B/A≦4 (1)

where A is the number of moles of the metal element constituting the metal oxide, and B is the number of moles of Si constituting SiOₓ (0≦x≦0.8). This limitation enables the negative electrode active material to obtain a large capacity and good cycle performance. Moreover, the range where the compatibility between high capacity and life performance is obtained is preferably as follows: 1≦B/A≦3.

Next, a method of producing a negative electrode active material for a nonaqueous electrolyte battery according to this embodiment will be explained.

The negative electrode active material may be synthesized through the complexing of SiOₓ (0≦x≦0.8) particles and the metal oxide particles, mixing with the carbon material, complexing and baking treatment. The complexing of SiOₓ particles and the metal oxide particles can be performed by, for example, mechanochemical treatment in a solid phase or a liquid phase, stirring treatment, sputtering and vapor deposition.

Specific examples of the synthesizing process (synthesis of complex body particles) of complexing of SiOₓ (0≦x≦0.8) and the metal oxide particles may include a process in which Si particles or an Si layer is formed on the surface of the metal oxide particles by silicon vapor deposition or sputtering. According to this method, a negative electrode active material having the structure shown in FIG. 2 can be obtained. At this time, the particle diameter of the metal oxide particles is preferably 1 μm or less to increase the amount of Si to be carried.

Other examples of the synthesizing process (synthesis of complex body particles) of complexing of SiOₓ (0≦x≦0.8) and the metal oxide particles include a method in which Si and SiO₂ are complexed using mechanochemical treatment, this complexed material is further complexed with the metal oxide by using mechanochemical treatment and then, the obtained complexed material is baked. This method ensures that the complexed particles are easily coagulated and a negative electrode active material having the structure shown in FIG. 1 can be obtained. At this time, the molar ratio of Si/SiO₂ is preferably 2≦Si/SiO₂≦8 and more preferably 3≦Si/SiO₂≦5. The baking temperature is preferably in the range of 900 to 1200° C.

Examples of the method of complexing with carbon include mechanochemical treatment, chemical vapor deposition and liquid phase treatment. In the mechanochemical treatment, the complex particles, graphite and other carbon materials are complexed using a planetary ball mill. In the chemical vapor deposition, carbon raw materials such as toluene and benzene are introduced onto the heated complex particle material and carbonized on the surface of the complex particles to coat the surface of the complex particles. In the liquid phase treatment, the complex particles are dispersed in a dissolved polymer or monomer and baked after polymerized and solidified to carbonize in an inert atmosphere.

A nonaqueous electrolyte battery using the aforementioned negative electrode active material will be explained in detail. This nonaqueous electrolyte battery comprises a positive electrode, a negative electrode and a nonaqueous electrolyte.

### 1) Positive Electrode

The positive electrode has a structure in which a positive electrode active material layer containing an active material is carried on one or both surfaces of a positive electrode current collector.

The thickness of the above positive electrode active material layer on one surface is preferably 10 to 150 μm from the viewpoint of keeping the large-current performance and cycle life of the battery. Accordingly, when the active material layer is carried on each surface of the positive electrode current collector, the total thickness of the positive electrode active material layer is preferably in the range of 20 to 300 μm. The thickness of the positive electrode active material layer on one surface is more preferably 30 to 120 μm. When the positive electrode active material layer falls in this range, the large-current performance and cycle life are improved.

The positive electrode active material layer may contain a conductive agent besides the positive electrode active material.

The positive electrode active material layer may contain a binder which binds the positive electrode materials to each other.

Examples of the positive electrode active material include various oxides, for example, manganese dioxide, lithium-manganese composite oxide (for example, LiMn₂O₄ and LiMnO₂), lithium-containing cobalt oxide (for example, LiCoO₂) and lithium-containing nickel-cobalt oxide (for example, LiNi_{0.8}Co_{0.2}O₂). Particularly, when lithium-manganese composite oxide, lithium-containing cobalt oxide or lithium-containing nickel-cobalt oxide is used, a high voltage is obtained and therefore, these oxides are preferable.

Examples of the conductive agent may include acetylene black, carbon black and graphite.

Specific examples of the binder to be used may include polytetrafluoroethylene (PTFE), polyvinylidene fluoride (PVdF), ethylene-propylene-diene copolymer (EPDM) and styrene-butadiene rubber (SBR).

With regard to the ratio of the positive electrode active material, conductive agent and binder to be compounded, it is preferable that the positive electrode active material be 80 to 95% by weight, the conductive agent be 3 to 20% by weight and the binder be 2 to 7% by weight because good large-current performance and cycle life are obtained.

As the current collector, a conductive substrate having a porous structure or non-perforated conductive substrate may be used. These conductive substrates may be formed from, for example, aluminium, stainless steel or titanium. The thickness of the current collector is preferably 5 to 20 μm. This is because, when the thickness of the current collector falls in this range, the balance between the strength of the electrode and weight reduction is maintained.

### 2) Negative Electrode

The negative electrode has a structure in which a negative electrode active material layer containing a negative electrode active material according to the embodiment is carried on one or both surfaces of a negative electrode current collector.

The thickness of the above negative electrode active material layer on one surface is preferably 10 to 150 μm. Accordingly, when the negative electrode active material layer is carried on each surface of the negative electrode current collector, the total thickness of the negative electrode active material layer is in the range of 20 to 300 μm. The thickness of the negative electrode active material layer on one surface is more preferably 30 to 100 μm. When the negative electrode active material layer falls in this range, the large-current performance and cycle life are outstandingly improved.

The negative electrode active material layer may contain a binder which binds the negative electrode active materials to each other. As the binder, for example, polytetrafluoroethylene (PTFE), polyvinylidene fluoride (PVdF), ethylene-propylene-diene copolymer (EPDM) or styrene-butadiene rubber (SBR) may be used.

The negative electrode active material layer may contain a conductive agent. Examples of the conductive agent may include acetylene black, carbon black and graphite.

As the current collector, a conductive substrate having a porous structure or non-perforated conductive agent may be used. These conductive substrates may be formed from, for example, copper, stainless steel or nickel. The thickness of the current collector is preferably 5 to 20 μm. This is because, when the thickness of the current collector falls in this range, the balance between the strength of the electrode and weight reduction is maintained.

### 3) Nonaqueous Electrolyte

As the nonaqueous electrolyte, a nonaqueous electrolytic solution, polymer electrolyte impregnated with an electrolyte, polymer electrolyte or inorganic solid electrolyte may be used.

The nonaqueous electrolytic solution is a liquid electrolytic solution prepared by dissolving an electrolyte in a nonaqueous solvent and retained in a gap between electrode groups.

As the nonaqueous solvent, propylene carbonate (PC), ethylene carbonate (EC) or mixed solvent of PC or EC and a nonaqueous solvent (hereinafter referred to as a second solvent) which has a lower viscosity than PC or EC is primarily used.

As the second solvent, for example, chain carbonates is preferable. Among these chain carbonates, preferable examples include dimethyl carbonate (DMC), methyl ethyl carbonate (MEC), diethyl carbonate (DEC), ethyl propionate, methyl propionate, γ-butyrolactone (BL), acetonitrile (AN), ethyl acetate (EA), toluene, xylene, or methyl acetate (MA). These second solvents may be used either singly or in combinations of two or more. Particularly, the second solvent more preferably has a donor number of 16.5 or less.

The viscosity of the second solvent is preferably 2.8 cP or less at 25° C. The ratio of ethylene carbonate or propylene carbonate in the mixed solvent is preferably 10% to 80% by volume. The ratio of ethylene carbonate or propylene carbonate is more preferably 20% to 75% by volume.

Examples of the electrolyte contained in the nonaqueous electrolytic solution include lithium salts such as lithium perchlorate (LiClO₄), lithium hexafluorophosphate (LiPF₆), lithium borofluoride (LiBF₄), lithium hexafluoroarsenate (LiAsF₆), lithium trifluoromethasulfonate (LiCF₃SO₃) and lithium bistrifluoromethylsulfonylimide [LiN(CF₃SO₂)₂]. Among these compounds, LiPF₆ or LiBF₄ is preferably used.

The amount of the electrolyte dissolved in a nonaqueous solvent is designed to be preferably 0.5 to 2.0 mol/L.

### 4) Separator

When a nonaqueous electrolytic solution or an electrolyte-impregnation-type polymer electrolyte is used, a separator may be used. As the separator, a porous separator is used. As the material for the separator, a porous film containing polyethylene, polypropylene or polyvinylidene fluoride (PVdF) or a nonwoven fabric made of a synthetic resin may be used. Among these compounds, a porous film made of polyethylene, polypropylene or the both is preferable because this film can improve the safety of a secondary battery.

The thickness of the separator is preferably designed to be 30 μm or less. When the thickness exceeds 30 μm, the distance between positive and negative electrodes is increased and there is therefore a risk of increasing internal resistance. Also, the lower limit of the thickness is preferably designed to be 5 μm. When the thickness is designed to be less than 5 μm, the strength of the separator is significantly reduced and there is therefore a risk that internal short-circuiting is easily developed. The upper limit of the thickness is more preferably designed to be 25 μm and the lower limit of the thickness is more preferably designed to be 10 μm.

The separator preferably has a thermal shrinkage factor of 20% or less measured when it is kept at 120° C. for one hour. When the thermal shrinkage factor exceeds 20%, this increases the possibility of short-circuiting being developed by heating. The thermal shrinkage factor is more preferably designed to be 15% or less.

The separator preferably has a porosity ranging from 30 to 70%. This reason is as follows. When the porosity is less than 30%, there is a risk that it is difficult to obtain high ability of retaining an electrolyte. When the porosity exceeds 60%, on the other hand, there is a risk that only insufficient separator strength is obtained. The porosity is more preferably in the range of 35 to 70%.

The separator preferably has an air permeability of 500 s/100 cm³ or less. When the air permeability exceeds 500 s/100 cm³, there is a risk that it is difficult to obtain a high lithium ion mobility in the separator. Also, the lower limit of the air permeability is preferably 30 s/100 cm³. When the air permeability is designed to be less than 30 s/100 cm³, there is a risk that only insufficient separator strength is obtained.

The upper limit of the air permeability is preferably designed to be 300 s/100 cm³ and also, the lower limit of the air permeability is preferably designed to be 50 s/100 cm³.

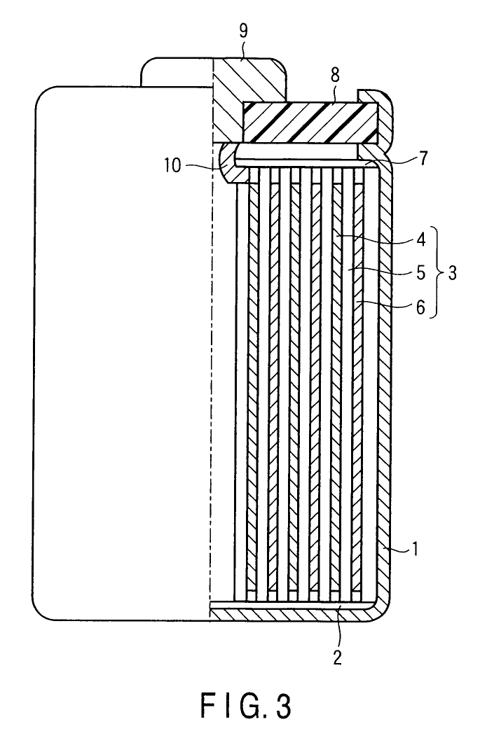

A cylindrical nonaqueous electrolyte secondary battery which is an example of a nonaqueous electrolyte battery will be explained in detail with reference to FIG. 3.

A bottomed cylindrical container 1 made of stainless steel is provided with an insulation body 2 disposed on the bottom. An electrode group 3 is stored in the container 1. The electrode group 3 has a structure in which a band material obtained by laminating a positive electrode 4, a separator 5, a negative electrode 6 and a separator 5 is coiled spirally such that the separator 5 is positioned outside.

A nonaqueous electrolytic solution is stored in the container 1. An insulation paper 7 with an opening in its center is disposed on the upper part of the electrode group 3. An insulation seal plate 8 is disposed on the upper opening part of the container 1 and is fixed to the container 1 by inwardly caulking a part near the upper opening part. A positive electrode terminal 9 is fitted in the center of the insulation seal plate 8. One end of a positive electrode lead 10 is connected to the positive electrode 4 and the other end is connected to the positive electrode terminal 9. The negative electrode 6 is connected to the container 1 which is a negative electrode terminal, through a negative electrode lead (not shown).

In the above FIG. 3, an example in which the present invention is applied to a cylindrical nonaqueous electrolyte secondary battery has been explained. However, the present invention may be likewise applied to a rectangular-type nonaqueous electrolyte secondary battery. Also, the electrode group stored in the container of the above battery is not limited to the above spiral form but may have a form in which a positive electrode, separator and negative electrode are laminated in this order plurally.

Also, in the aforementioned FIG. 3, an example in which the present invention is applied to a nonaqueous electrolyte secondary battery using an outside package made of a metal can has been explained. However, the present invention may be likewise applied to a nonaqueous electrolyte secondary battery using an outside package made of a film material. As the film material, a laminate film including a thermoplastic resin layer and an aluminum layer is preferable.

### EXAMPLES

Specific examples in which the battery shown in FIG. 3 was actually produced in various conditions explained in the following examples will be given to describe the effect of each example. The present invention is not limited to these examples.

### Example 1

Using a planetary ball mill (Model: P-5, manufactured by Fritsch), synthesis was made using the following raw material composition in the following operational conditions of a ball mill and baking condition.

When a ball mill was used, a silicon nitride container having a volume of 500 mL and a 10 mmφ silicon nitride ball were used. Also, when the sample was sealed, the operation was performed in an Ar box so that the treatment was carried out in an inert gas atmosphere. As the raw material, 6 g of an SiO₂ powder having an average particle diameter of 1 μm and 11.3 g of an Si powder having an average particle diameter of 30 μm were used and these components were mixed at a frequency of 150 rpm for a treating time of 18 hours. 12.2 g of an alumina (Al₂O₃) powder having an average particle diameter of 1 μm as an oxide was added to the mixture, which was treated at 220 rpm for 12 hours.

The obtained SiOₓ—Al₂O₃ complex particles (0≦x≦0.8) were complexed with a graphite material by using a planetary ball mill in the following manner. 3 g of a graphite powder having an average particle diameter of 6 μm was added as a carbon material to 10 g of the complex particles and the mixture was mixed at a frequency of 120 rpm for a treating time of 18 hours.

The mixture obtained by the ball mill treatment was complexed with hard carbon. 10 g of the complex particles was added to a mixed solution of 5.0 g of furfuryl alcohol, 10 g of ethanol and 0.125 g of water and the resulting mixture was kneaded. 0.2 g of dilute hydrochloric acid which was a polymerization catalyst of furfuryl alcohol was further added to the kneaded mixture, which was then allowed to stand at ambient temperature to obtain complex particles.

The obtained carbon complex was baked at 1000° C. for 3 hours in Ar gas, cooled to ambient temperature, then, milled and screened by a 30 μm sieve to obtain a negative electrode active material. The obtained negative electrode active material had a structure shown in FIG. 1.

### Example 2

A negative electrode active material of Example 2 was obtained in the same manner as in Example 1 except that 12.8 g of magnesia (MgO) particles having an average particle diameter of 1 μm was added as the metal oxide particles.

### Example 3

A negative electrode active material of Example 3 was obtained in the same manner as in Example 1 except that 12.7 g of titania (TiO₂) particles having an average particle diameter of 1 μm was added as the metal oxide particles.

### Example 4

A negative electrode active material of Example 4 was obtained in the same manner as in Example 1 except that 19.6 g of zirconia (ZrO₂) particles having an average particle diameter of 1 μm was added as the metal oxide particles.

### Example 5

A negative electrode active material of Example 5 was obtained in the same manner as in Example 1 except that 26.1 g of ceria (CeO₂) particles having an average particle diameter of 10 μm was added as the metal oxide particles.

### Example 6

A negative electrode active material of Example 6 was obtained in the same manner as in Example 1 except that 13.5 g of SiO₂—Al₂O₃ glass (40 wt % alumina glass) having an average particle diameter of 5 μm was added as the oxide.

### Example 7

A sputtering apparatus was used to carry out synthesis by using the following raw material composition in the following baking condition.

At the time of Si-sputtering, 3 g of alumina (Al₂O₃) powders having an average particle diameter of 1 μm as the raw material was heated to 950° C. to carry out sputtering by using Si as the target.

The mixture obtained by the sputtering treatment was coated with carbon by using the following method. The Si-alumina complex particles were heated to 1000° C. in an electric furnace and Ar gas which had been bubbled in toluene was made to flow through the electric furnace. The Si-alumina complex particles were treated at an Ar gas flow rate of 50 cc/min for 6 hours to coat the surface of the particles with carbon to obtain complex particles.

The obtained complex powder was screened by a 30 μm sieve to obtain a negative electrode active material of Example 7. The obtained negative electrode active material had a structure shown in FIG. 2.

### Example 8

A chemical vapor deposition apparatus was used to carry out synthesis by using the following raw material composition in the following baking condition.

In the chemical vapor deposition, vapor deposition treatment was carried out using 3 g of alumina (Al₂O₃) powders having an average particle diameter of 1 μm under the condition of raw gas: SiH₄ and gas pressure: 15 mTorr, to obtain Si-alumina complex particles.

The mixture obtained by the chemical vapor deposition was complexed with hard carbon in the following manner. 2 g of the complex particles was added to a mixed solution of 5.0 g of furfuryl alcohol, 4 g of ethanol and 0.5 g of water and the resulting mixture was kneaded. 0.05 g of dilute hydrochloric acid which was a polymerization catalyst of furfuryl alcohol was further added to the kneaded mixture, which was then allowed to stand at ambient temperature to obtain complex particles.

The obtained Si—Al₂O₃-carbon complex was baked at 1000° C. for 3 hours in Ar gas, cooled to ambient temperature, then, milled and screened by a 30 μm sieve to obtain a negative electrode active material of Example 8. The obtained negative electrode active material had a structure shown in FIG. 2.

### Example 9

When complexed with hard carbon, 10 g of the complex particles was added to a mixed solution of 5.0 g of furfuryl alcohol, 10 g of ethanol, 0.125 g of water and 1.5 g of tetraethoxysilane (chemical formula: Si(OC₂H₅)₄) and the resulting mixture was kneaded. 0.2 g of dilute hydrochloric acid which was a polymerization catalyst of furfuryl alcohol was further added to the kneaded mixture, which was then allowed to stand at ambient temperature to obtain complex particles. The same processes as in Example 1, except for the above processes, were carried out to obtain a negative electrode active material of Example 9. The obtained negative electrode active material had a structure shown in FIG. 1.

### Example 10

A negative electrode active material of Example 10 was obtained in the same manner as in Example 1 except that 12.7 g of TiO₂ microparticles having an average particle diameter of 50 nm was added as the oxide.

### Comparative Example 1

Using a planetary ball mill (Model: P-5, manufactured by Fritsch), 10 g of an SiO powder having an average particle diameter of 45 μm as the raw material and 10 g of a graphite powder having an average particle diameter of 6 μm as the carbon material were added and the mixture was treated at 120 rpm for 18 hours.

The mixture obtained by the ball mill treatment was complexed with hard carbon in the following method. 3 g of the complex particles was added to a mixed solution of 5.0 g of furfuryl alcohol, 10 g of ethanol and 0.125 g of water and the resulting mixture was kneaded. 0.2 g of dilute hydrochloric acid which was a polymerization catalyst of furfuryl alcohol was further added to the kneaded mixture, which was then allowed to stand at ambient temperature to obtain complex particles.

The obtained carbon complex particles was baked at 1000° C. for 3 hours in Ar gas, cooled to ambient temperature, then, milled and screened by a 30 μm sieve to obtain a negative electrode active material of Comparative Example 1.

### Comparative Example 2

25 g of tetraethoxysilane and 10 g of triisopropoxy aluminum were mixed in 50 g of isopropanol and the mixture was stirred for about 6 hours. Then, 1.0 g of water and 0.2 g of dilute hydrochloric acid were added to the mixture to undergo a sol-gel reaction, thereby obtaining an oxide of Si and Al uniformly mixed. The Si—Al mixture oxide was dried under vacuum at 150° C., and then, 3.5 g of silicon was added, followed by mixing. Then, the resulting mixture was heat-treated under reduced pressure at 800° C. for 6 hours. Moreover, the oxide was coated with about 30 wt % of amorphous carbon by chemical vapor deposition to obtain a negative electrode active material of Comparative Example 2.

The active materials obtained in the above examples and comparative examples were subjected to various tests including X-ray diffraction method, SEM observation and charge-discharge test explained below, to evaluate the properties and charge-discharge performance of the active material.

### (X-Ray Diffraction Method)

The Obtained Powder Sample was Subjected to Powder X-ray diffraction to measure the half-value width of the peak of the Si (220) plane. The measurement was carried out by using an X-ray diffraction measuring device manufactured by Rigaku (Model: RINT-TTRIII) in the following condition.

Counter cathode: Cu
Tube voltage: 50 kV
Tube current: 300 mA
Scanning speed: 1° (2θ)/min

The half-value width (°[2θ]) of the peak of Miller index (220) of Si which appeared at d=1.92 Å (2θ=47.2°) was measured from the diffraction pattern. Also, when the peak of Si (220) and the peaks of other substances contained in the active material partly overlap on each other, the peaks were isolated from each other to measure each half-value width.

The half-value width (°[2θ]) of the peak of graphite (002) which appeared at d=3.35 to 3.4 Å (2θ: about 26°) was likewise measured from the diffraction pattern to obtain the half-value width of the carbonaceous material phase.

### (SEM Observation)

The powder of each active material obtained in Examples and Comparative Examples was subjected to SEM-EDX measurement to examine the size of the metal oxide phase in the active material. Specifically, the powder sample was sealed in an epoxy resin, which was then solidified and abraded such that the section of the sample was exposed from the surface. After gold was vapor-deposited on the abraded surface, the metal oxide phase was identified by mapping using EDX to detect an average sectional size as the average size of the metal oxide phase.

### (Measurement of Molar Ratio [B/A])

The elemental composition of the obtained sample was examined by ICP light emission analysis. The molar ratio of B (silicon)/A (metal element) was calculated from the results of the measurement.

### (Charge-Discharge Test)

30 wt % of graphite having an average particle diameter of 6 μm and 12 wt % of polyvinylidene fluoride were added to the obtained sample and kneaded using N-methylpyrrolidone as a dispersion medium. The resulting kneaded mixture was applied to a copper foil having a thickness of 12 μm, which was then rolled, and dried under vacuum at 100° C. for 12 hours to make a test electrode. Using a counter electrode, a reference electrode made of metal Li, and an electrolytic solution prepared by dissolving 1 M LiPF₆ in a nonaqueous solvent obtained by blending EC and DEC in a ratio by volume of 1:2, a battery was produced in an argon atmosphere and subjected to a charge-discharge test. As to the charge-discharge condition, a charge operation was carried out at a current density of 1 mA/cm² until a difference in electric potential between the reference electrode and the test electrode was reduced to 0.01V, further, a constant-voltage charge operation was carried out at 0.03V for 8 hours and a discharge operation was carried out at a current density of 1 mA/cm² until a difference in electric potential between the reference electrode and the test electrode was increased to 1.5V. Moreover, this charge-discharge operation was repeated 50 times to calculate the retentive ratio of the discharge capacity to the initial discharge capacity.

The initial charge-discharge capacity efficiency was calculated as the percentage (%) on the initial charge capacity of the discharge capacity in the first cycle.

Next, similarly, a charge operation was carried out at a current density of 1 mA/cm² until a difference in electric potential between the reference electrode and the test electrode was reduced to 0.01V, further, a constant-voltage charge operation was carried out at 0.03V for 8 hours and a discharge operation was carried out at a current density of 10 mA/cm² until 1.5V. The ratio of the discharge capacity when the current density was 10 mA/cm² to the discharge capacity when the current density was 1 mA/cm² was obtained to evaluate the large-current performance.

Tables 1 and 2 show an Si crystallite size found from the half-value width of the Si (220) peak obtained by powder X-ray diffraction, the size of the metal oxide phase in the active material found from SEM observation, molar ratio (B/A), the half-value width of the peak derived from the (002) plane of a graphite structure in the X-ray diffraction, the discharge capacity in the charge-discharge test, initial charge-discharge efficiency, capacity retentive ratio after 50 cycles and the capacity retentive ratio of the discharge capacity when the current density was 10 mA/cm² to the discharge capacity when the current density was 1 mA/cm², which is a large-current performance.

TABLE 1

| | | | | | Half-value |
|---|---|---|---|---|---|
| | | | Si | | width of |
| | | Average size of | crystallite | Molar | carbonaceous |
| | | metal oxide phase | size | ratio | material |
| | Metal oxide | (μm) | (nm) | (B/A) | (°[2θ]) |
| Example 1 | Al₂O₃ | 0.6 μm | 32 | 2.0 | 2.7 |
| Example 2 | MgO | 0.7 μm | 35 | 1.5 | 2.8 |
| Example 3 | TiO₂ | 0.5 μm | 34 | 3.0 | 2.8 |
| Example 4 | ZrO₂ | 0.6 μm | 32 | 3.0 | 2.6 |
| Example 5 | CeO₂ | 0.7 μm | 33 | 3.0 | 2.9 |
| Example 6 | SiO₂—Al₂O₃ | 0.6 μm | 48 | 2.0 | 2.8 |
| | glass | | | | |
| Example 7 | Al₂O₃ | 1.0 μm | 18 | 0.7 | 3.0 |
| Example 8 | Al₂O₃ | 1.0 μm | 21 | 1.0 | 3.2 |
| Example 9 | Al₂O₃ | 0.5 μm | 29 | 2.2 | 3.2 |
| Example 10 | TiO₂ | 50 nm | 15 | 3.0 | 2.7 |
| Comparative | — | None | 7 | — | 2.8 |
| Example 1 | | | | | |
| Comparative | — | — | >100 | — | 4.4 |
| Example 2 | | | | | |

TABLE 2

| | | | Retentive ratio | |
|---|---|---|---|---|
| | | Initial charge- | of discharge | Large- |
| | Discharge | discharge | capacity after | current |
| | capacity | efficiency | 50 cycles | performance |
| | (mAh/g) | (%) | (%) | (%) |
| Example 1 | 960 | 88 | 81 | 54 |
| Example 2 | 935 | 89 | 79 | 52 |
| Example 3 | 941 | 90 | 82 | 70 |
| Example 4 | 780 | 88 | 83 | 63 |
| Example 5 | 678 | 91 | 93 | 64 |
| Example 6 | 918 | 89 | 87 | 57 |
| Example 7 | 640 | 92 | 89 | 61 |
| Example 8 | 731 | 89 | 91 | 62 |
| Example 9 | 912 | 83 | 92 | 49 |
| Example 10 | 889 | 77 | 76 | 52 |
| Comparative | 720 | 75 | 95 | 36 |
| Example 1 | | | | |
| Comparative | 658 | 68 | 70 | 21 |
| Example 2 | | | | |

As is clear from Tables 1 and 2, each nonaqueous electrolyte battery obtained in Examples 1 to 10 had higher initial charge-discharge efficiency and large-current performance than Comparative Examples 1 and 2. The negative electrode active material of Comparative Example 1 had no metal oxide and the fixed phase of Si was silicon oxide and therefore, a side reaction between silicon oxide and lithium occurred, causing deterioration in initial charge-discharge efficiency and large-current performance. Also, the negative electrode active material of Comparative Example 2 corresponds to the negative electrode active material described in JP-A 2005-259697 (KOKAI). In the negative electrode active material of Comparative Example 2, silicon and aluminum were uniformly dispersed, so that not only was the size of aluminum oxide not defined, but also the contact of silicon with the carbon material was reduced, resulting in deterioration in initial charge-discharge efficiency and large-current performance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A negative electrode active material comprising:
complex particles comprising a metal oxide having an average size of 50 nm to 1 μm and SiOₓ (0≦x≦0.8) supported on a surface of the metal oxide; and
a carbonaceous material phase which binds the complex particles.

2. The active material according to claim 1, wherein the metal oxide is at least one type selected from the group consisting of alumina, magnesia, titania, zirconia, ceria and silica-alumina glass.

3. The active material according to claim 1, which satisfies formula (I) given below:
0.5≦B/A≦4 (1)
where A is the number of moles of a metal element of the metal oxide, and B is the number of moles of Si of SiOₓ (0≦x≦0.8).

4. The active material according to claim 1, wherein the carbonaceous material phase comprises an amorphous carbon of which a half-value width of a peak derived from a (002) plane of a graphite structure in X-ray diffraction is 1° or more in terms of 2 theta angle (2θ).

5. The active material according to claim 1, wherein the carbonaceous material phase is an amorphous body obtained by baking an Si-containing polymer.

6. The active material according to claim 1, wherein a size of a silicon crystallite measured by X-ray diffraction is in the range of 1 to 300 nm.

7. A nonaqueous electrolyte battery comprising:
a negative electrode comprising the negative electrode active material according to claim 1;
a positive electrode; and
a nonaqueous electrolyte.

8. A negative electrode active material comprising:
a complex particle comprising a metal oxide having an average size of 50 nm to 1 μm and SiOₓ (0≦x≦0.8) supported on a surface of the metal oxide; and
a carbonaceous material phase which covers a surface of the complex particle.

9. The active material according to claim 8, wherein the metal oxide is at least one type selected from the group consisting of alumina, magnesia, titania, zirconia, ceria and silica-alumina glass.

10. The active material according to claim 8, which satisfies formula (I) given below:
0.5≦B/A≦4 (1)
where A is the number of moles of a metal element of the metal oxide, and B is the number of moles of Si of SiOₓ (0≦x≦0.8).

11. The active material according to claim 8, wherein the carbonaceous material phase comprises an amorphous carbon of which a half-value width of a peak derived from a (002) plane of a graphite structure in X-ray diffraction is 1° or more in terms of 2 theta angle (2θ).

12. The active material according to claim 8, wherein the carbonaceous material phase is an amorphous body obtained by baking an Si-containing polymer.

13. The active material according to claim 8, wherein a size of a silicon crystallite measured by X-ray diffraction is in the range of 1 to 300 nm.

14. A nonaqueous electrolyte battery comprising:
a negative electrode comprising the negative electrode active material according to claim 8;
a positive electrode; and
a nonaqueous electrolyte.
